(19) United States
(12) Patent Application Publication
(10) Pub. No.: US 2026/0064763 A1
(43) Pub. Date: Mar. 5, 2026

(54) RETRIEVAL-AUGMENTED GENERATION FOR LARGE LANGUAGE MODELS

(71) Applicant: Western Digital Technologies, Inc., San Jose, CA (US)

(72) Inventors: Lay Chuan Lim, Bayan Lepas (MY); Sunny Chan Zi Yang, Perai (MY); Seng Wee Saw, Bayan Lepas (MY)

(21) Appl. No.: 18/822,414

(22) Filed: Sep. 2, 2024

(51) Int. Cl. G06F 16/535; G06F 16/56

(52) U.S. Cl. CPC G06F 16/535; G06F 16/56

(57) ABSTRACT

Images are identified in reference files and removed from the reference files. Image data for the removed images are stored in at least one memory and the removed images are replaced with image path strings indicating storage locations in the at least one memory of image data corresponding to the removed images. The reference files are stored in a data storage device including image path strings for the removed images as a knowledge base for a Large Language Model (LLM) in responding to queries. In one aspect, a response to a query is received from the LLM and an image path string is identified in the response. Image data is retrieved from the at least one memory using the identified image path string, and the received response is displayed with an image replacing the identified image path string using the retrieved image data.

### BACKGROUND

Retrieval-Augmented Generation (RAG) has gained popularity for chatbot development, since it can allow the chatbot to produce more accurate and up-to-date responses by using additional information that is relevant to a query. In this regard, RAG can improve the responses of Large Language Models (LLMs) used by chatbots to respond to queries by providing an authoritative and relevant knowledge base in addition to the LLM's training data. This can extend the LLM's capabilities to specific domains, such as medical fields, engineering fields, or legal fields, for example. The knowledge base accessed by an LLM using RAG can include, for example, industry-specific documentation, such as medical journals, engineering documentation, or law review articles. Some knowledge bases for RAG can include an organization's proprietary information, such as human resource data or manufacturing reports, that can be used by the LLM to provide more specific responses on a particular employee or product, for example.

Although RAG-based chatbots can provide more accurate and up-to-date responses, such chatbots generally lack the ability to provide graphical content to supplement its responses. This is because LLMs are text generative Artificial Intelligence (AI) models that receive a textual query and return a textual response. For many fields, the inclusion of graphical content as part of a response can significantly improve the understanding of the response and can provide better guidance in completing tasks. Some chatbots are currently capable of providing images, but these chatbots usually rely on another image generative AI model, such as a diffusion model (e.g., OpenAI's DALL-E), in addition to the LLM. However, such image generation typically requires significant additional processing resources and may introduce inaccuracies into the information being presented in the response. Other chatbots may also provide links to references used in generating a response, but such links do not integrate the relevant images into the response and may require a user to spend additional time reviewing the references for the relevant images.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a block diagram of an example system for providing images with responses from a Large Language Model (LLM) according to one or more embodiments.

FIG. 2 depicts an example of responding to a query using an LLM according to one or more embodiments.

FIG. 3 illustrates an example of replacing an image path string in a response from an LLM with an image according to one or more embodiments.

FIG. 4 is a flowchart for a file preparation process to use files as context for an LLM according to one or more embodiments.

FIG. 5 is a flowchart for an LLM response handling process according to one or more embodiments.

FIG. 6 is a flowchart for an LLM preparation process according to one or more embodiments.

FIG. 7 is a flowchart for an image path check process according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example System Environments

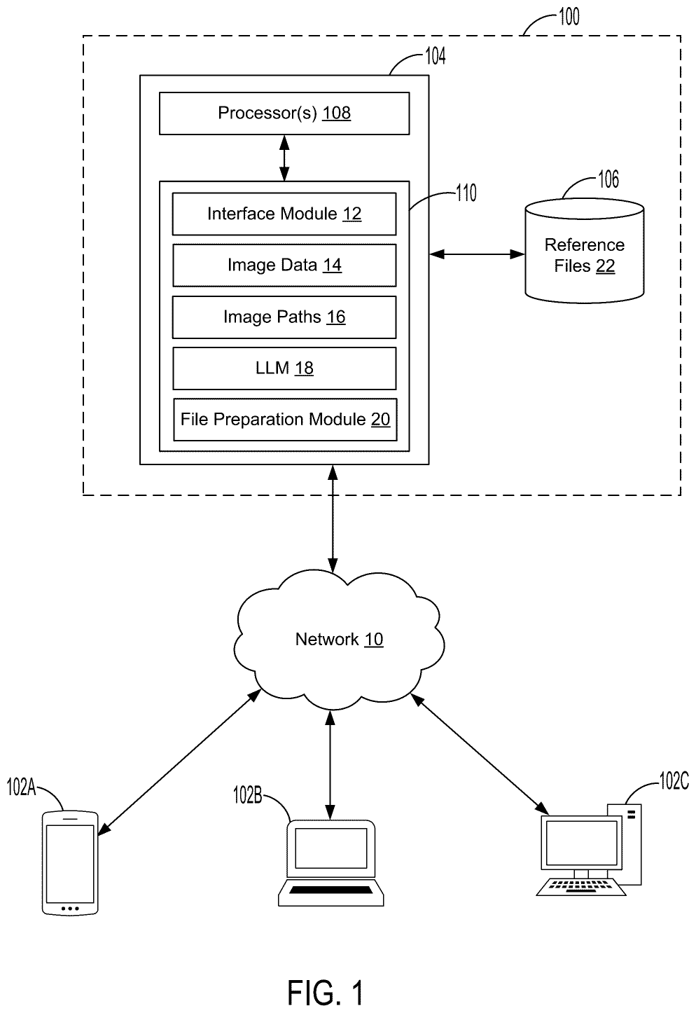

FIG. 1 is a block diagram of an example system 100 for providing images with responses from Large Language Model (LLM) 18 to clients 102 according to one or more embodiments. As shown in FIG. 1, system 100 includes host 104 and Data Storage Device (DSD) 106. In some implementations, host 104 and DSD 106 can form, for example, a computer system, such as a desktop or one or more servers. In this regard, host 104 and DSD 106 may be housed separately, such as where host 104 may access DSD 106 as a cloud server, or where host 104 and DSD 106 are separate servers in the same data center. In other implementations, host 104 and DSD 106 may be housed together as part of a single server for clients 102A, 102B, and 102C. In other implementations, host 104 and DSD 106 may not be co-located and may be in different geographical locations.

Host 104 includes one or more processors 108 and one or more local memories 110. Processor(s) 108 can include, for example, circuitry such as one or more Central Processing Units (CPUs), Graphics Processing Units (GPUs), microcontrollers, Digital Signal Processors (DSPs), Application-Specific Integrated Circuits (ASICs), Field Programmable Gate Arrays (FPGAs), hard-wired logic, analog circuitry and/or a combination thereof. In some implementations, processor(s) 108 can include a System on a Chip (SoC) that may be combined with one or more memories 110 of host 104 and/or an interface for communicating with clients 102 and/or DSD 106. In the example of FIG. 1, processor(s) 108 execute instructions, such as instructions from interface module 12, LLM 18, file preparation module 20, an operating system of host 104, or other applications executed by host 104.

Host 104 can communicate with DSD 106 via a bus or network, which can include, for example, a Compute Express Link (CXL) bus, Peripheral Component Interconnect express (PCIe) bus, a Network on a Chip (NoC), a Local Area Network (LAN), or a Wide Area Network (WAN), such as the internet or another type of bus or network. In some examples, host 104 can include software for controlling communication with DSD 106, such as a device driver of an operating system of host 104.

In the example of FIG. 1, host 104 can communicate with clients 102A, 102B, and 102C via network 10, which can include a LAN or WAN, such as the internet. Each of clients 102A, 102B, and 102C can include one or more processors and a memory for executing a user interface application for enabling a user of the client 102 to input queries that are sent to interface module 12 of host 104 and to receive responses to the queries from interface module 12. Interface module 12 may serve as a chatbot that uses LLM 18 to respond to the queries. The responses can be displayed on a display of the client 102, which can include, for example, a smartphone or tablet (i.e., client 102A), a laptop (i.e., client 102B), or a desktop computer (i.e., client 102C). As discussed in more detail below, unlike conventional responses from an LLM, the responses provided via interface module 12 from LLM 18 can include one or more images in addition to text. As used herein, an “image” refers to any type of graphical representation, such as a chart, a diagram, a photograph, or a drawing, for example.

As shown in the example of FIG. 1, host 104 includes its own local memory or memories 110, which can include, for example, a Dynamic Random Access Memory (DRAM), Static Random Access Memory (SRAM), Magnetoresistive RAM (MRAM) or other type of Storage Class Memory (SCM), or other type of solid-state memory. Memory or memories 110 store executable instructions that can be executed by processor(s) 108, such as interface module 12, LLM 18, or file preparation module 20, or portions of any of the foregoing which may be loaded from a DSD, such as DSD 106. In addition, memory or memories 110 can store data used by interface module 12, such as image data 14 and image paths 16.

While the description herein refers to solid-state memory generally, it is understood that solid-state memory may comprise one or more of various types of memory devices such as flash integrated circuits, NAND memory (e.g., Single-Level Cell (SLC) memory, Multi-Level Cell (MLC) memory (i.e., two or more levels), or any combination thereof), NOR memory, Electrically Erasable Programmable Read-Only Memory (EEPROM), Chalcogenide RAM (C-RAM), Phase Change Memory (PCM), Programmable Metallization Cell RAM (PMC-RAM or PMCm), Ovonic Unified Memory (OUM), Resistive RAM (RRAM), Ferroelectric Memory (FeRAM), MRAM, 3D-XPoint memory, and/or other discrete Non-Volatile Memory (NVM) chips, or any combination thereof.

In the example of FIG. 1, memory or memories 110 of host 104 store interface module 12, or portions thereof for execution by processor(s) 108. In some implementations, interface module 12 can include a chatbot that may comprise a Natural Language Processing (NLP) engine that analyzes and interprets queries received from clients 102 and/or a dialog manager that controls the flow and logic of interaction between a user interface of a client 102 and interface module 12.

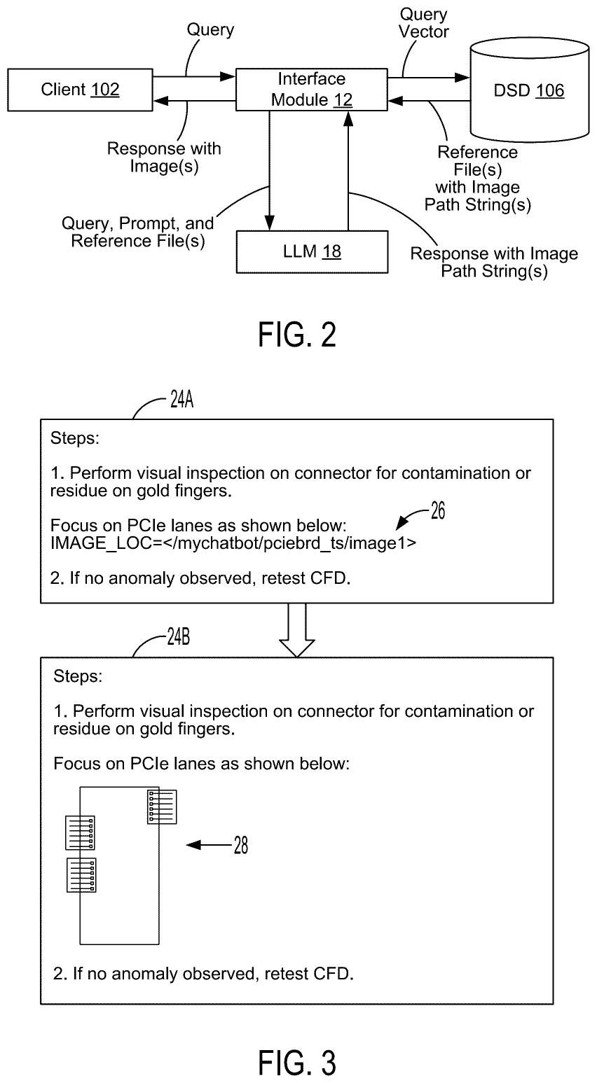

As discussed in more detail below with reference to FIG. 2., interface module 12 in some implementations may also use an AI model to transform queries into query vectors to identify one or more reference files, or portions thereof, that are related to a query among reference files 22 stored in DSD 106. The related reference file or files, or portions thereof, can be provided to LLM 18 as context for responding to the query. Reference files 22 serve as a knowledge base for LLM 18 as part of a Retrieval-Augmented Generation (RAG) for LLM 18. As noted above, RAG can improve the responses of LLMs by providing an authoritative and relevant knowledge base in addition to the LLM's training data. This can extend or focus the LLM's capabilities for specific domains, such as, for technical use by programmers, medical staff, or engineers, or enable the LLM to access an organization's proprietary information, such as human resource data or manufacturing reports to provide specific responses for the organization.

Notably, reference files 22 stored in DSD 106 have been prepared by file preparation module 20 to remove images from reference files 22 and to replace the removed images with image path strings indicating storage locations in memory or memories 110 for image data corresponding to the removed images. In some implementations, file preparation module 20 may also maintain coherency between image data 14, image paths 16, and reference files 22. In some cases, a portion of the image path string may include a file name and an image name that can be used to search image paths 16 when a reference file or image has been deleted or modified to update image data 14 and/or image paths 16. In this regard, file preparation module 20 may process a reference file again after it has been modified to replace any new images with new image path strings, remove image path strings for deleted images, or replace the image data for a modified image. The modified reference file may then be stored in DSD 106 to replace the previous version of the reference file.

Interface module 12 provides a prompt to LLM 18 to include image path strings from reference files 22 if useful or informative in forming part of a response. In this regard, LLM 18 can be prompted to treat the image path strings found in reference files 22 as images. Interface module 12 can then replace the image path strings in responses received from LLM 18 with image data that can be displayed as images at a client 102 by retrieving the image data at the storage location in image data 14 that corresponds to the image path string.

This can enable the inclusion of images in responses provided by LLM 18 without incurring the significant additional processing and memory resource costs of using an image generative AI model, such as a diffusion model (e.g., OpenAI's DALL-E). In addition, the images provided in the response from interface module 12 are taken directly from the original reference files that form the knowledge base and are therefore less likely to suffer from inaccuracies, such as hallucinations that may be introduced by an image generation AI model. Moreover, the user does not need to review the reference files that were used to generate the response for relevant images, as would be the case for current chatbots that may provide only links to reference files used to generate a response.

As used herein, a “reference file” includes a related set of data and is not limited to files used in a hierarchal file system. In this regard, reference files 22 can include data arranged as objects used in object storage and/or arranged as conventional files used in a file system.

Image data 14 includes data for images that have been removed from reference files 22 and stored locally at host 104 in memory or memories 110. Interface module 12 can access image data 14 using an image path string included in a response from LLM 18 to identify a storage location of the image data corresponding to an image path string. The image path string in the response is then replaced by interface module 12 with the image data for rendering or displaying an image by a client 102 that is included in the response.

Image paths 16 can include a data structure, such as a table or key value store, that stores image path strings for images removed from reference files 22. Interface module 12 may compare an image path string returned by LLM 18 as part of a response to at least one image path string stored in image paths 16 as a safeguard against errors introduced by LLM 18 in the image path string, such as a hallucination that may slightly change the format of the image path string. In some implementations, interface module 12 may perform a similarity search or fuzzy logic search to identify a closest or most similar image path string to an image path string returned by LLM 18 and then use the closest file path string to retrieve image data. Interface module 12 may also use a limit on the degree of difference from the image file path string returned by LLM 18 for the closest image path string to help guard against retrieving the wrong image data.

LLM 18 can process textual queries to respond with natural language. LLMs are typically trained using large amounts of text and can be used for a wide variety of tasks, including, for example, translation, writing, and question answering. LLMs or other types of AI models can be used by the public at large, such as with ChatGPT developed by OpenAI and Bard developed by Google. However, LLMs can also be used by specific groups, such as within a company or a university, or by a particular department or group of users in an organization. In the example of FIG. 1, LLM 18 uses prompts from interface module 12 in addition to the query to behave a particular way. The prompt from interface module 12 can include instructions for LLM 18 to answer the query based on context provided to LLM 18 that includes one or more reference files, or portions thereof, from reference files 22.

The prompt can also “hypnotize” LLM 18 to output images by using image path strings found by LLM 18 in the one or more reference files or portions provided to it. Such a prompt can include instructions specifying that image path strings following a particular format, such as “IMAGE_LOC: <image path>” can be extracted from the reference file context and included in a textual response if useful for the response. The prompt may, for example, further explain that such image path strings will be converted into images for display to the user as part of the response.

DSD 106 can include one or more storage devices, such as one or more Solid State Drives (SSDs) and/or Hard Disk Drives (HDDs) for storing reference files 22. In some implementations, DSD 106 can also store a vector database that enables reference files 22 or portions thereof (i.e., “chunks” of the reference files that may have a logical arrangement such as a section or chapter of a document) to be searched relatively quickly for relevant information in the knowledge base. The reference files are transformed using an AI model into mathematical vector embeddings of a high dimension to represent the information for the reference file. The vector embeddings can be stored in the vector database with vector metadata, which may be included in a vector index and/or metadata index for the vector database to enable efficient searching of the vector database.

As discussed in more detail below, interface module 12 can receive a query from a user or application, such as from a remote user interface executed at a client 102, for example, or from an application executed at host 104, and then identify similar or related reference files or portions thereof stored in DSD 106. In some implementations, interface module 12 may convert or transform the query into a query vector using the same AI model that generated the vector embeddings for the reference files. The query vector, in some implementations, may be provided to DSD 106 to identify one or more vector embeddings in a vector database that are similar to the query vector. The query vector may not have values for all the dimensions that are represented by values in the vector embeddings, but a similarity search can still be performed using the values for dimensions that are present in the query vector.

In some cases, circuitry of DSD 106 may use an Approximate Nearest Neighbor (ANN) search to locate one or more vector embeddings in the vector database that represent one or more reference files or portions thereof from reference files 22. In other cases, one or more processors 108 of host 104 may instead search the vector database or otherwise identify reference files related or similar to the query. The similar or related reference files, or portions thereof, are then provided to LLM 18 to help in answering the query by providing context or semantic information for the query.

The search may include an ANN search with operations such as determining a cosine of an angle between vectors, a Euclidian distance between vectors, or a dot product between vectors to identify similar vectors and return a certain number of nearest or most similar vector embeddings with respect to particular search criteria. A pre-filtering or post-filtering using vector metadata may also be performed to reduce the search field or to reduce the number of similar vector embedding results.

DSD 106 or host 104 may then identify one or more reference files or portions of reference files from which the one or more similar vector embeddings were derived. The reference file or files can be identified using vector metadata that is included as part of the vector database or its index. In some implementations, the vector metadata may have been used as part of a filtering operation in the ANN search. The vector metadata may indicate a relationship between the vector embedding and the reference file or portion of the reference file used to create the vector embedding.

Those of ordinary skill in the art will appreciate with reference to the present disclosure that other implementations of system 100 may differ. For example, one or both of image data 14 and image paths 16 may be stored in a different location, such as in a memory external to host 104 or in DSD 106. As another example variation, other implementations may not include clients 102 communicating with host 104 remotely through network 10 and can instead include host 104 providing a display for users to interact with interface module 12 to provide queries for LLM 18 and display responses from LLM 18. As yet another example variation, LLM 18 may not be executed by host 104 and can instead be executed by another host, such as a cloud server. As yet another example variation, file preparation module 20 and interface module 12 may be combined in some implementations, or file preparation module 20 may be executed by a different device, such as by DSD 106 or a dedicated server that prepares files for storage in DSD 106, which may also calculate vector embeddings for reference files 22 in some implementations.

FIG. 2 depicts an example of responding to a query using LLM 18 according to one or more embodiments. As shown in the example of FIG. 2, client 102 submits a textual query to interface module 12, such as through a user interface executed by client 102. Interface module 12 transforms the query into a query vector using an AI model that was used to transform reference files 22 stored in DSD 106. The resulting query vector is a mathematical representation of the query in a vector embedding space that can be compared to vector embeddings representing reference files 22 or portions thereof in the vector embedding space to locate one or more vector embeddings that are similar to the vector query or located close to the query vector in the vector embedding space. In some implementations, DSD 106 may perform an ANN search to identify the one or more similar vector embeddings, which in turn, can be used to identify reference file(s) or portions thereof that are returned to interface module 12.

The refence file(s) or portions thereof are then provided to LLM 18 with the query and a prompt as context for responding to the query. The prompt can instruct LLM 18 to treat image path strings identified in the context as images that can be used in responding to the query if useful for the response. The prompt can also inform LLM 18 of a format for the image path strings so that LLM 18 can recognize the image path strings and extract relevant image path strings for inclusion in the response. LLM 18 then provides a textual response to the query with one or more image path strings as part of the textual response. In some implementations, the image path strings may, for example, take the form of a Uniform Resource Locator (URL), and interface module 12 may take the form of a chatbot implemented in conjunction with a web browser.

Interface module 12 identifies the one or more image path strings included in the response and retrieves image data from image data 14 using the one or more image path strings received in the response from LLM 18. Interface module 12 may then replace the one or more image path strings with one or more sets of image data (e.g., an image file or image object) in the response received from LLM 18 so that the corresponding image or images for the one or more image path strings can be rendered by client 102 for display as part of the response to the query.

Those of ordinary skill in the art will appreciate with reference to the present disclosure that other implementations of responding to a query may differ from the example shown in FIG. 2. For example, a separate module may be used to generate a query vector, or a different device such as host 104 or a dedicated vector database server may be used to identify the similar or related reference files or portions thereof instead of DSD 106.

FIG. 3 illustrates an example of replacing an image path string in response 24A from LLM 18 with an image 28 according to one or more embodiments. As shown in the example of FIG. 3, textual response 24A is received from LLM 18 in response to a textual query asking how to troubleshoot a PCIe board for a device. Textual response 24A from LLM 18 includes two steps and image path string 26 in place of an image extracted from a reference file showing the locations of PCIe lanes for visual inspection. LLM 18 adds image path string 26 in response 24A where the image is to be located.

Interface module 12 identifies image path string 26 in textual response 24A and uses image path string 26 to retrieve image data from image data 14 for replacing image path string 26 in the combined textual and graphical response 24B. As shown in FIG. 3, the combined textual and graphical response 24B includes image 28 when displayed to provide helpful instruction and a more complete response than solely relying on the textual portions of the response returned by LLM 18.

Those of ordinary skill in the art will appreciate with reference to the present disclosure that other examples of a combined textual and graphical response from interface module 12 may differ from the example shown in FIG. 3. For example, a response from interface module 12 may include multiple images corresponding to different image path strings. In some cases, LLM 18 may not need to include any images in a response and therefore not include image path strings in the response to interface module 12. In such cases, interface module 12 may simply pass the response received from LLM 18 to client 102 without adding any image data to the response.

### Example Processes

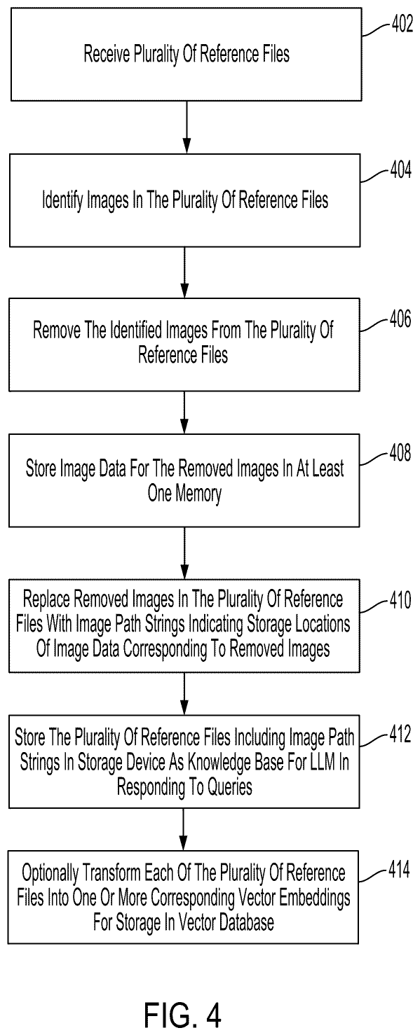

FIG. 4 is a flowchart for a file preparation process to use files as context for an LLM according to one or more embodiments. The process of FIG. 4 can be performed by, for example, processor(s) of host 104 executing file preparation module in FIG. 1. In this regard, processor(s) 108 can, in some implementations, comprise a means for performing the functions of the file preparation process of FIG. 4.

In block 402, a plurality of reference files is received for a knowledge base to be used by an LLM for RAG. In some implementations, the reference files may be received over time, such as when users or applications of clients or of a host store the reference files in a storage system. In such cases, the reference files may be identified by the users or applications as being relevant to particular topics or the reference files may be analyzed for relevance. In other implementations, the plurality of reference files can be provided as a batch of previously stored reference files for preparation as part of the knowledge base.

In block 404, images are identified in the reference files, such as by using an image analyzer. As noted above, the images can include various different types of graphical information, such as charts, diagrams, photos, or drawings.

In block 406, the identified images are removed from the reference files, and corresponding image data for rendering the removed images are stored in at least one memory (e.g., as image data 14 in a memory or memories 110 of host 104 in FIG. 1). In some cases, the image data may already be formatted as part of the reference file and ready for extraction. In other cases, the image data may need to be converted or derived from the file.

In block 410, the removed images are replaced in the reference files with image path strings indicating storage locations of the image data corresponding to the removed images. In some implementations, the image path strings can include, for example, a file path or other logical identifier for locating the image data. In other implementations, the image path string may include, for example, a key value for accessing the image data in a key value store.

In block 412, the plurality of reference files is stored in a DSD (e.g., DSD 106 in FIG. 1) with the image path strings in place of the images appearing in the original reference files. The plurality of reference files can then be used as a knowledge base for the LLM in responding to queries.

In block 414, each of the reference files can optionally be transformed into one or more corresponding vector embeddings representing the data in the reference files. The vector embeddings are then stored in a vector database and may also be indexed for faster identification of the corresponding reference files. As discussed above, the vector embeddings can be used to identify reference files or portions thereof that are related or similar to a query. In some implementations, the generation of the vector embeddings for the reference files may be part of the file preparation process when storing the modified reference files with the image path strings. In other implementations, the generation of the vector embeddings for the reference files may be performed at a different time than the replacement of the images in the reference files with image path strings. In yet other implementations, the identification of similar or related reference files or portions thereof may be performed without using a vector database such that block 414 is omitted in the file preparation process.

Those of ordinary skill in the art will appreciate with reference to the present disclosure that other implementations of the file preparation process of FIG. 4 may differ. For example, blocks 404 to 414 may be performed iteratively for each reference file received in block 402. In this regard, the file preparation process of FIG. 4 may be performed for one reference file at a time such that a single reference file is received in block 402, as opposed to a plurality of reference files.

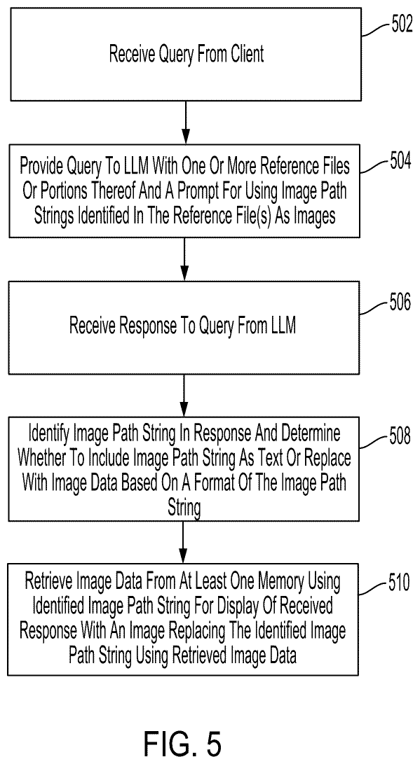

FIG. 5 is a flowchart for an LLM response handling process according to one or more embodiments. The process of FIG. 5 can be performed by, for example, one or more processors 108 of host 104 in FIG. 1 executing interface module 12. In this regard, processor(s) 108 can, in some implementations, comprise a means for performing the functions of the LLM response handling process of FIG. 5.

In block 502, a query is received from a client, such as from one of clients 102A, 102B, or 102C in FIG. 1. The query may be received by, for example, an interface module for the LLM and may include a textual or natural language query provided by a user of the client. In other implementations, the query may be received as a textual query from an application executed by a host or a client.

In block 504, the query is provided to the LLM with one or more reference files or portions thereof as context for responding to the query. In this regard, the LLM may use RAG to provide relevant and/or current information from a knowledge base for answering the query. In addition, a prompt is provided to the LLM to use image path strings identified in the one or more reference files or portions thereof as images that can be included as part of the response to the query. The prompt may also include instructions on a format for the image path strings and instructions on placement of the image path strings within the response.

In block 506, a textual response is received from the LLM, and one or more image path strings are identified in the response in block 508. It is then determined whether to leave the one or more image path strings as text in the response or to replace the one or more image path strings with image data. In making this determination, the format of the image path string may be compared to a particular format indicating that the image path string should be replaced with image data. For example, a prefix of the image path string such as IMAGE_LOC may indicate that the string should be replaced with image data.

In block 510, image data is retrieved from at least one memory (e.g., memory or memories 110 of host 104 in FIG. 1) using the identified image path string, which indicates a storage location in the at least one memory, such as a logical identifier or file path for locating the image data. The image data is then added to the response to replace the image path string for display of the received response with a corresponding image. The response may then be provided to the client for rendering the response including displaying the image in a combined textual and graphical response with the image located within the response at the previous location of the image path string.

Those of ordinary skill in the art will appreciate with reference to the present disclosure that other implementations of the LLM response handling process of FIG. 5 may differ. For example, blocks 508 and 510 may be performed iteratively to identify and determine whether to replace different image path strings in the response with image data.

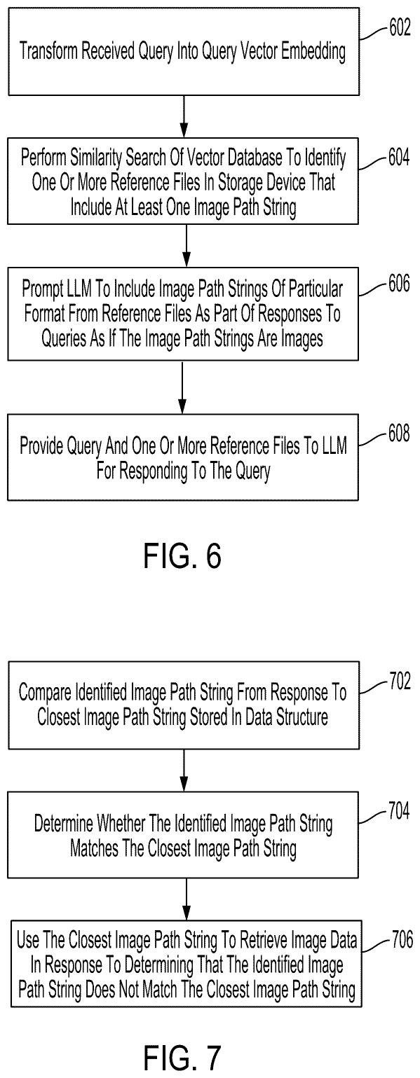

FIG. 6 is a flowchart for an LLM preparation process according to one or more embodiments. The LLM preparation process of FIG. 6 can be included as a sub-process of an LLM response handling process, such as FIG. 5 discussed above. The process of FIG. 6 can be performed by, for example, one or more processors 108 of host 104 in FIG. 1 executing interface module 12. In this regard, processor(s) 108 can, in some implementations, comprise a means for performing the functions of the LLM preparation process of FIG. 6.

In block 602, a received query is transformed into a query vector to represent the query. The query can be transformed using an AI model that was used to transform reference files in a knowledge base into one or more corresponding vector embeddings. The query vector provides a mathematical representation of the query in a vector embedding space that can be used to perform a similarity search to identify one or more vector embeddings in the vector embedding space that are in close proximity to the query vector in one or more dimensions of the vector embedding. The reference files or portions thereof that are represented by the identified vector embeddings can then be provided to the LLM as context for responding to the query.

In block 604, a similarity search is performed of a vector database that includes the vector embeddings representing the reference files or portions thereof. The corresponding reference files or portions thereof include at least one image path string. As discussed above with reference to the file preparation process of FIG. 4, the reference files stored in the knowledge base have been prepared to remove images with image path strings indicating storage locations of image data for the corresponding images.

In block 606, the LLM is prompted to include image path strings of a particular format from reference files as part of its responses to queries as if the image path strings are images. The prompt can provide “hypnosis instructions” to the LLM to behave differently than it otherwise would by providing images as image path strings. In this regard, LLMs typically cannot provide images in their responses, which are generally limited to textual responses. The prompt can also, for example, instruct the LLM to provide the image path strings next to the related text in the response.

In block 608, the query and one or more reference files or portions thereof are provided to the LLM for responding to the query. The one or more reference files or portions thereof are the result of the similarity search performed in block 604 and are provided as context for answering the query.

Those of ordinary skill in the art will appreciate with reference to the present disclosure that other implementations of the LLM preparation process of FIG. 6 may differ. For example, the prompting of the LLM in block 606 may be performed for each query provided to the LLM or may be performed for a batch of queries provided to the LLM. As another example, the prompt provided in block 606 can include the query and the one or more reference files or portions thereof as context for responding to the query. In such examples, block 608 can be included as part of block 606.

FIG. 7 is a flowchart for an image path check process according to one or more embodiments. The image path check process of FIG. 7 can be performed as a sub-process of an LLM response handling process, such as FIG. 5 discussed above, to verify that no errors have been introduced by the LLM into the image path string. The process of FIG. 7 can be performed by, for example, one or more processors 108 of host 104 in FIG. 1 executing interface module 12. In this regard, processor(s) 108 can, in some implementations, comprise a means for performing the functions of the image path check process of FIG. 7.

In block 702, an image path string identified in a response received from an LLM is compared to a closest image path string stored in a data structure. With reference to the example system 100 in FIG. 1 discussed above, interface module 12 of host 104 may compare an image path string included in a response from LLM 18 with one or more image path strings stored in image paths 16 to identify a closest image path string. In some implementations, a similarity search or semantic lookup may be performed of the image path strings included in the data structure to find the closest image path string.

In block 704, it is determined whether the image path string identified in the response matches the closest image path string in the data structure. Due to the generative nature of the LLM, an image path string provided in a response may not always completely follow an image path string provided in the one or more reference files or portions provided to the LLM to respond to a query (i.e., the context). The image path string in the response may have mutated with slight changes. For example, the following mutations may have occurred to the image path string

```
IMAGE_LOC=</my_location_root/my_department/my_title/imagename01.jpg>:
  IMAGE_LOC=“my_location_root/my_department/my_title/imagename01.jp
  g”, which uses quotation marks (i.e., “, ”) instead of angle brackets (i.e., <,
  >);
  IMAGE_LOC=<\my_location_root\my_department\my_title\imagename01.j
  pg>, which uses backslashes (i.e., \) instead of forward slashes (i.e., /); and
  IMAGE_LOC=<http:/my_location_root/my_department/my_title/imagenam
  e01.jpg>, which adds “http:” to the string.
```

In block 706, the closest image path string is used to retrieve image data in response to determining that the identified image path string does not match the closest image path string. By using the closest image path string, the retrieval of the image data can be ensured despite modifications that may have been made by the generative LLM. In some implementations, the degree or amount of difference between the image path string provided in the response from the LLM and the closest image path string may be limited to a certain amount or degree of changes to prevent retrieving the wrong image data.

Those of ordinary skill in the art will appreciate with reference to the present disclosure that other implementations of the image path check process of FIG. 7 may differ. For example, in some implementations, the closest image path string may be used to retrieve the image data regardless of whether it matches or not with the image path string provided in the response from the LLM.

As discussed above, the foregoing systems and processes for preparing reference files and handling queries and responses for LLMs can provide images in responses from LLMs that would otherwise include only text. The use of image path strings as discussed above can provide a relatively low cost and less resource intensive solution to providing images in responses from LLMs as compared to using an additional image generative AI model in addition to the LLM, which may also introduce inaccuracies or hallucinations into the response. Moreover, the combined textual and graphical responses provided by the present disclosure can integrate relevant images from the knowledge base into responses without requiring a user to spend additional time reviewing references from the knowledge base for relevant images.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general-purpose processor, a GPU, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, Read-Only Memory (ROM) memory, Erasable Programmable ROM (EPROM) memory, EEPROM memory, registers, hard disk, a removable media, an optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

1. A host, comprising:
at least one memory configured to store image data; and
at least one processor, individually or in combination, configured to:
provide a query to a Large Language Model (LLM);
receive a response to the query from the LLM;
identify, in the response, an image path string indicating a removed image from a reference file used by the LLM in generating the response; and
retrieve image data from the at least one memory using the identified image path string for displaying the received response with an image replacing the identified image path string using the retrieved image data.

2. The host of claim 1, wherein the at least one processor, individually or in combination, is further configured to determine, based on a format of the identified image path string, whether to include the identified image path string as text in the response or to replace the identified image path string with image data in the response.

3. The host of claim 1, wherein the at least one processor, individually or in combination, is further configured to prompt the LLM to include image path strings of a particular format from reference files as part of responses to queries as if the image path strings are images.

4. The host of claim 1, wherein the at least one processor, individually or in combination, is further configured to:
transform the query into a query vector;
perform a similarity search of a vector database using the query vector to identify one or more reference files or portions thereof stored in a data storage device, wherein the one or more reference files or portions thereof include at least one image path string indicating a removed image; and
provide the one or more reference files or portions thereof to the LLM for responding to the query.

5. The host of claim 1, wherein the at least one processor, individually or in combination, is further configured to:
receive a plurality of reference files;
identify images in the plurality of reference files;
remove the identified images from the plurality of reference files;
store image data for the removed images in the at least one memory;
replace the removed images in the plurality of reference files with image path strings indicating storage locations in the at least one memory of image data corresponding to the removed images; and
store the plurality of reference files including the image path strings for the removed images in a data storage device as a knowledge base for the LLM in responding to queries.

6. The host of claim 5, wherein the at least one processor, individually or in combination, is further configured to transform each of the plurality of reference files into one or more corresponding vector embeddings for storage in a vector database.

7. The host of claim 1, wherein the at least one processor, individually or in combination, is further configured to:
compare the identified image path string from the response to a closest image path string stored in a data structure;
determine whether the identified image path string matches the closest image path string; and
in response to determining that the identified image path string does not match the closest image path string, use the closest image path string to retrieve the image data for displaying the image.

8. A method performed for a Large Language Model (LLM), the method comprising:
receiving a plurality of reference files for storage in a knowledge base used by the LLM, wherein each reference file of the plurality of reference files includes a related set of data;
identifying data corresponding to images in the plurality of reference files using an image analyzer;
removing the identified data from the plurality of reference files;
storing image data for the removed data in at least one memory;
replacing each instance of the removed data in the plurality of reference files with an image path string indicating a storage location in the at least one memory of image data corresponding to the removed data; and
storing the plurality of reference files including image path strings for the removed data in a data storage device as at least part of the knowledge base for the LLM in responding to queries.

9. The method of claim 8, further comprising prompting the LLM to include image path strings of a particular format from reference files as part of responses to queries as if the image path strings are images.

10. The method of claim 8, wherein the image path strings follow a particular format in responses from the LLM indicating that the image path strings correspond to images.

11. The method of claim 8, further comprising transforming each of the plurality of reference files into one or more corresponding vector embeddings for storage in a vector database.

12. The method of claim 8, further comprising:
receiving a query for the LLM;
transforming the query into a query vector;
performing a similarity search of a vector database using the query vector to identify one or more reference files of the plurality of reference files or portions thereof, wherein the one or more reference files or portions thereof include at least one image path string indicating removed data corresponding to an image; and
providing the query and the one or more reference files or portions thereof to the LLM for responding to the query.

13. The method of claim 8, further comprising:
receiving a response to the query from the LLM;
identifying an image path string in the response;
retrieving image data from the at least one memory using the identified image path string; and
replacing the identified image path string in the received response with the retrieved image data for display of an image corresponding to the retrieved image data as part of the response.

14. The method of claim 13, further comprising determining, based on a format of the image path string, whether to include the identified image path string as text in the response or to replace the identified image path string with image data.

15. The method of claim 13, further comprising:
comparing the identified image path string from the response to a closest image path string stored in a data structure;
determining whether the identified image path string matches the closest image path string; and
in response to determining that the identified image path string does not match the closest image path string, using the closest image path string to retrieve the image data for displaying the image.

16. A host, comprising:
at least one memory configured to store image data; and
means for:
providing a query to a Large Language Model (LLM);
receiving a response to the query from the LLM;
identifying, in the response, an image path string indicating a removed image from a reference file used by the LLM in generating the response; and
retrieving image data from the at least one memory using the identified image path string for displaying the received response with an image replacing the identified image path string using the retrieved image data.

17. The host of claim 16, further comprising means for determining, based on a format of the identified image path string, whether to include the identified image path string as text in the response or to replace the identified image path string with image data.

18. The host of claim 16, further comprising means for prompting the LLM to include image path strings of a particular format from reference files as part of responses to queries as if the image path strings are images.

19. The host of claim 16, further comprising means for:
receiving a plurality of reference files;
identifying images in the plurality of reference files;
removing the identified images from the plurality of reference files;
storing image data for the removed images in the at least one memory;
replacing the removed images in the plurality of reference files with image path strings indicating storage locations in the at least one memory of image data corresponding to the removed images; and
storing the plurality of reference files including image path strings for the removed images in a data storage device as a knowledge base for the LLM in responding to queries.

20. The host of claim 16, further comprising means for:
comparing the identified image path string from the response to a closest image path string stored in a data structure;
determining whether the identified image path string matches the closest image path string; and
in response to determining that the identified image path string does not match the closest image path string, using the closest image path string to retrieve the image data for displaying the image.
